(19) United States
(12) Patent Application Publication
(10) Pub. No.: US 2008/0219565 A1
(43) Pub. Date: Sep. 11, 2008

(54) TRAINING DEVICE AND PATTERN RECOGNIZING DEVICE

(75) Inventor: Hiroshi Hattori, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/040,993

(22) Filed: Mar. 3, 2008

(30) Foreign Application Priority Data
Mar. 6, 2007 (JP) P2007-056088

(51) Int. Cl. G06K 9/62

(52) U.S. Cl. 382/224

(57) ABSTRACT

According to an aspect of the present invention, there is provided a training device for a classifier including weak classifiers, the training device including: a storing unit that stores sample images; a first calculator that acquires a local information for each of the sample images; and a training unit that trains one of the weak classifiers based on the local information, the training unit including: an second calculator that acquires an arrangement information for each of the sample images, a selector that selects one of combined informations being generated by combining the local information and the arrangement information, and a third calculator that acquires an identifying parameter for the one of the weak classifiers based on the selected combined informations.

### CROSS-REFERENCE TO RELATED APPLICATIONS

The entire disclosure of Japanese Patent Application No. 2007-056088 filed on Mar. 6, 2007 including specification, claims, drawings and abstract is incorporated herein by reference in its entirety.

### BACKGROUND OF THE INVENTION

1. Field of the Invention

An aspect of the present invention relates to a training device and a pattern recognizing device for detecting a specific pattern from an input image and for classifying divided areas of the input image into known identifying classes.

2. Description of the Related Art

A technique for detecting a specific pattern included in an input image or identifying a plurality of patterns into known classes is called a pattern recognizing (or identifying) technique.

In the recognition of the pattern, initially, an identifying function is trained by using sample data in which belonging classes are identified. As one of such training method, AdaBoost is proposed. In AdaBoost, a plurality of identifying devices having a low identifying performance (a plurality of weak classifiers) are used. The weak classifiers are trained and the trained weak classifiers are integrated to form an identifying device having a high identifying performance (strong classifier). The pattern recognition by the AdaBoost can realize a high recognition performance with a practical calculation cost, and thereby is widely used (for example, refer to P. Viola and M. Jones, “Rapid Object Detection using a Boosted Cascade of Simple Features”, IEEE conf. on Computer Vision and Pattern Recognition (CVPR), 2001).

In a method disclosed in the above mentioned document, each weak classifier performs identification based on a single feature quantity. As the feature quantity, a brightness difference between rectangular areas, which can be calculated at high speed, is employed.

When the single feature quantity is used for each weak classifier, the correlation of features cannot be effectively evaluated so that the identifying performance may be lowered. In Japanese patent application number JP2005-54780, a method for identifying based on a combination of a plurality of features in each of weak classifiers is disclosed.

In the above-described methods, a rectangular form (refer it to as a reference window) of a prescribed size is set in an input image, and an identification is performed by using a feature quantity calculated for the reference window. Therefore, the identification is performed from extremely local information so that an identifying performance may not be improved. Further, in the usual system, an identified result of points in the neighborhood considered to be useful for the identification is not considered. Further, in the case of an ordinary object recognition, such a mutual relation that a chair is frequently present near a desk can not be incorporated in the above-described method. Thus, there is a problem that the improvement of an identifying accuracy is limited.

### SUMMARY OF THE INVENTION

According to an aspect of the present invention, there is provided a training device for a strong classifier configured to classify class of images of areas in an object image, the strong classifier including a plurality of weak classifiers, the training device including: a sample image storing unit configured to store sample images for training; a local information calculator configured to acquire a local information for each of local images of divided areas in each of the sample images; and a weak classifier training unit configured to train, based on the local information, a first weak classifier that is one of the weak classifiers, the weak classifier training unit including: an arrangement information calculator configured to acquire an arrangement information including a positional relation information between each of marked areas located in each of the sample images and each of peripheral areas located on periphery of each of the marked areas and an identifying class information that is previously identified for each of the peripheral areas, a combined information selector configured to select a first combined information from a plurality of combined informations being generated by combining the local information and the arrangement information, and an identifying parameter calculator configured to acquire, based on the first combined information, a first identifying parameter for the first weak classifier.

According to another aspect of the present invention, there is provided a pattern recognizing device including: an input unit configured to input an object image; a local information calculator configured to acquire a local information used for identifying areas in the object image; T of arrangement information calculators configured to acquire T of arrangement informations based on an estimated identifying class information for each of peripheral areas located on periphery of each of marked areas located in the object image and based on a positional relation information between each of the marked areas and each of the peripheral areas; T of weak classifiers configured to acquire T of weak identifying class informations respectively for each of the areas based on the local information and based on each of the arrangement informations; and a final identifying unit configured to acquire a final identifying class for each of the areas based on the weak identifying class informations; wherein T is an integer larger than 1.

According to still another aspect of the present invention, there is provided a method for training a strong classifier configured to classify class of images of areas in an object image, the strong classifier including a plurality of weak classifiers, the method including: storing sample images for training; acquiring a local information for each of local images of divided areas in each of the sample images; and training, based on the local information, a first weak classifier that is one of the weak classifiers, the step of training including: acquiring an arrangement information including a positional relation information between each of marked areas located in each of the sample images and each of peripheral areas located on periphery of each of the marked areas and an identifying class information that is previously identified for each of the peripheral areas, selecting a first combined information from a plurality of combined informations being generated by combining the local information and the arrangement information, and acquiring, based on the first combined information, a first identifying parameter for the first weak classifier.

According to still another aspect of the present invention, there is provided a method for recognizing a pattern, including: inputting an object image; acquiring a local information used for identifying areas in the object image; acquiring T of arrangement informations based on an estimated identifying class information for each of peripheral areas located on periphery of each of marked areas located in the object image and based on a positional relation information between each of the marked areas and each of the peripheral areas; acquiring T of weak identifying class informations respectively for each of the areas based on the local information and based on each of the arrangement informations; and acquiring a final identifying class for each of the areas based on the weak identifying class informations; wherein T is an integer larger than 1.

According to still another aspect of the present invention, there is provided a computer program product for enabling a computer system to perform a training of a strong classifier configured to classify class of images of areas in an object image, the strong classifier including a plurality of weak classifiers, the computer program product including: software instructions for enabling the computer system to perform predetermined operations; and a computer readable medium storing the software instructions; wherein the predetermined operations including: storing sample images for training; acquiring a local information for each of local images of divided areas in each of the sample images; and training, based on the local information, a first weak classifier that is one of the weak classifiers, the step of training including: acquiring an arrangement information including a positional relation information between each of marked areas located in each of the sample images and each of peripheral areas located on periphery of each of the marked areas and an identifying class information that is previously identified for each of the peripheral areas, selecting a first combined information from a plurality of combined informations being generated by combining the local information and the arrangement information, and acquiring, based on the first combined information, a first identifying parameter for the first weak classifier.

According to still another aspect of the present invention, there is provided a computer program product for enabling a computer system to perform a pattern recognition, the computer program product including: software instructions for enabling the computer system to perform predetermined operations; and a computer readable medium storing the software instructions; wherein the predetermined operations including: inputting an object image; acquiring a local information used for identifying areas in the object image; acquiring T of arrangement informations based on an estimated identifying class information for each of peripheral areas located on periphery of each of marked areas located in the object image and based on a positional relation information between each of the marked areas and each of the peripheral areas; acquiring T of weak identifying class informations respectively for each of the areas based on the local information and based on each of the arrangement informations; and acquiring a final identifying class for each of the areas based on the weak identifying class informations; wherein T is an integer larger than 1.

### BRIEF DESCRIPTION OF THE DRAWINGS

Embodiment may be described in detail with reference to the accompanying drawings, in which:

FIG. 1 is a block diagram of a training device of one embodiment;

FIG. 2 is a block diagram of a pattern recognizing device of one embodiment;

FIG. 3 is a diagram for explaining a spatial arrangement feature;

FIG. 4 is a diagram for explaining a local feature;

FIG. 5 is a diagram for explaining a method for deciding a threshold value; and

FIG. 6 is a diagram for explaining a relation between a probability distribution and a comparing table.

### DETAILED DESCRIPTION OF THE INVENTION

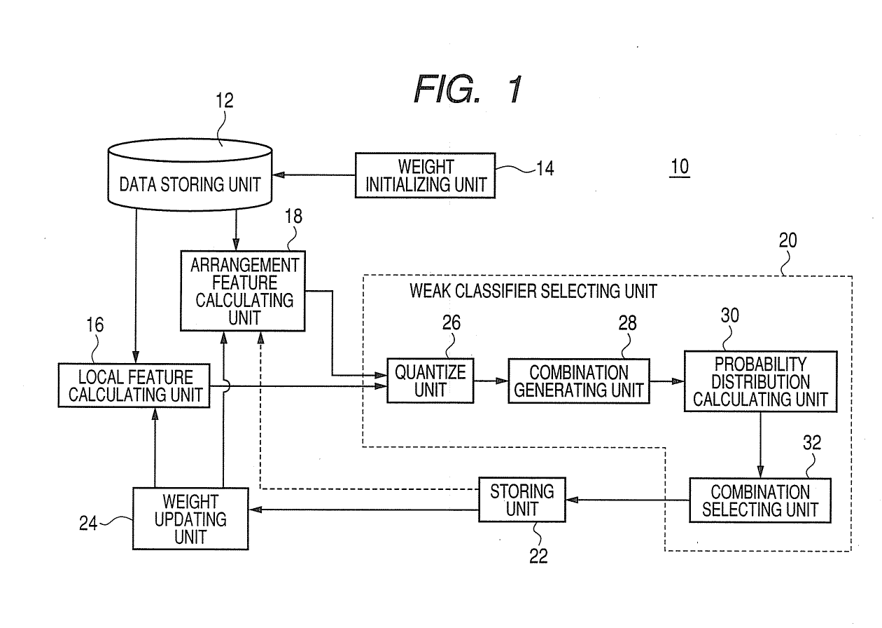

By referring to FIGS. 1 to 6, a training device 10 of one embodiment of the present invention and a pattern recognizing device 50 using an identifying device acquired by using of the training device 10 will be described below.

In this embodiment, a two-class identification problem, such as a problem of extraction of a road area from an image acquired by the vehicle-mounted device, is assumed. In this embodiment, the input image is considered to be an object image and divided into two areas that are a road part and a residual part (part except the road part of the object image).

Initially, the training device 10 will be described, and then, the pattern recognizing device 50 will be described.

### (Training Device 10)

The training device 10 of this embodiment is described by referring to FIG. 1 and FIGS. 3 to 6.

The training device 10 uses an AdaBoost as a training algorithm. The AdaBoost is a training method for changing the weight of a training sample one by one to generate a different identifying device (refer it to as a weak classifier) and combining a plurality of weak classifiers together to form an identifying device of a high accuracy (refer it to as a strong classifier).

### (1) Structure of Training Device 10

FIG. 1 is a block diagram of the training device 10.

As shown in FIG. 1, the training device 10 includes a data storing unit 12, a weight initializing unit 14, a local feature calculating unit 16, an arrangement feature calculating unit 18, a weak classifier selecting unit 20, a storing unit 22 and a weight updating unit 24. The weak classifier selecting unit 20 further includes a quantize unit 26, a combination generating unit 28, a probability distribution calculating unit 30 and a combination selecting unit 32.

Each of the above-mentioned units of the training device 10 may be realized by a program stored in a recording medium of a computer.

In the specification, the vector quantity is expressed by, for example, “vector x”, “vector l”, and “vector g”, and the scalar quantity is expressed by, for example, “x”, “y”, “i” and “l”.

### (2) Data Storing Unit 12

The data storing unit 12 stores many sample images each of that includes an object to be recognized. For example, an image including a road is stored as the sample image.

Here, a cut out partial image is not stored for each class and an original image is held as the sample image. Generally, a plurality of objects to be recognized are contained in the sample image. Therefore, a class label that shows belonging class of each point (each pixel) is stored with a brightness. The suitable class label for each point is set, for example, by a manual input.

In a below-described explanation, N training samples (vector x₁, y₁), (vector x₂, y₂), . . . , (vector x_{N}, y_{N}) are regarded as training data. The N training samples are obtained from the sample images and stored in the data storing unit 12. And, a weight added thereto is changed to train T weak classifiers h₁ (vector x), h₂ (vector x), . . . , h_{T} (vector x) one by one and to obtain a strong classifier H(vector x) formed by the trained weak classifiers.

Here, i designates an index number assigned to the points of all the sample images. A vector xᵢ (i=1, 2, . . . , N) designates a below-described feature vector, and yᵢ (i=1, 2, . . . , N) designates a class label thereof. Assuming that the labels of two identifying classes are −1 and +1, a value that can be taken by yᵢ (i=1, 2, . . . , N) is −1 or +1. Since both the output values of the weak classifier and the strong classifier are class labels, values that can be taken by them are also −1 or +1.

### (3) Weight Initializing Unit 14

The weight initializing unit 14 initializes the weights of the individual training samples. The weight is a coefficient set according to the importance of the training sample when the image is identified by the one weak classifier.

For example, when an equal weight is set to all the training samples, the weight of an i-th training sample is given by

D₁(i)=1/N (1)

This weight is used when the first weak classifier h₁(vector x) is trained and updated one after another by the below-described weight updating unit 24.

### (4) Local Feature Calculating Unit 16

The local feature calculating unit 16 extracts a plurality of local features as local information used for recognizing a pattern. The local features are extracted for each points on the sample image stored in the data storing unit 12 by using a rectangular window set around a point as the center, as shown in FIG. 4.

As the local features herein, there are calculated a two dimensional coordinate (u, v) of the image of that point, an average of a brightness in the window, a brightness distribution in the window, an average of a brightness gradient in the window, a dispersion of the brightness gradient in the window and other feature quantity anticipated to be valid for identifying the image.

In a below-described identifying process, when it is recognized that a certain feature is invalid for identifying the image, the pattern recognizing device 50 may save the calculation of the feature. Therefore, feature quantities that may be possibly valid for identifying the image are calculated as much as possible, initially.

The total number of the features is set to L and an L dimensional vector l obtained by collecting the features is expressed by

Vector l=(l₁, l₂, . . . , l_{L}) (2)

This vector is called a local feature vector. The local feature calculating unit 16 calculates lᵢ respectively for the points i of all the images stored in the data storing unit 12 and outputs N local feature vectors.

### (5) Arrangement Feature Calculating Unit 18

The arrangement feature calculating unit 18 calculates an arrangement feature as arrangement information for each point (each pixel) on the sample images stored in the data storing unit 12. In the arrangement feature, since the improvement of an identifying accuracy is limited when only local information is used, the arrangement information is also used to identify the marked point. The arrangement information is related to identifying classes of areas in the periphery of a marked point as a central point. The arrangement information (arrangement feature) specifies the identifying classes of the areas in the periphery of the marked point.

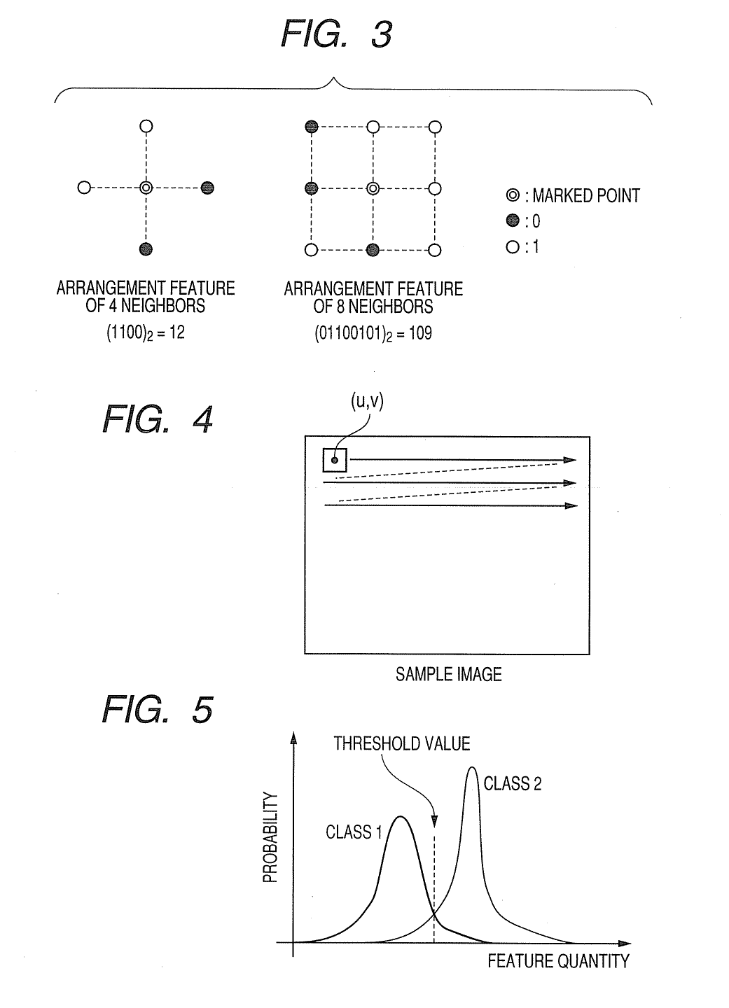

The arrangement feature is calculated from the class labels of points in the vicinity of each point. By referring to FIG. 3, the arrangement feature is described.

An example of the arrangement feature of 4 neighbors is shown in a left part of FIG. 3. The arrangement feature of the 4 neighbors is calculated from the class labels in the upper, lower, right and left parts of the marked point. The class labels are −1 or +1, however, −1 is replaced by 0 in the arrangement feature calculating unit 18 for the purpose of simplifying a process. In this example, (1100)₂=12 is an arrangement feature quantity of the 4 neighbors.

An example of the arrangement feature of 8 neighbors is shown in a right part of FIG. 3. An arrangement feature quantity in this case is (01100101)₂=109.

The arrangement feature quantities of the 4 neighbors and the 8 neighbors are respectively expressed by a 4 bit and 8 dot gradation. To generalize it, when the number of the identifying classes is N, the arrangement feature quantity of F neighbors is expressed by an N-ary number of F figures.

Even in the same arrangement, values may be different depending on in which order 0 and 1 are expressed. For example, the arrangement feature quantity of the 4 neighbors in FIG. 3 is expressed by a binary number in order of the upper, left, right and lower parts. However, when this order is changed, a different value is obtained. Therefore, a predetermined order is used for each arrangement and the same order is used in the pattern recognizing device 50. This order specifies a positional relation, that is, the arrangement.

The arrangement feature calculating unit 18 calculates the arrangement feature quantities of G kinds such as the 4 neighbors or the 8 neighbors. A G dimensional arrangement feature vector G obtained by collecting the G arrangement feature quantities is expressed by

Vector g=(g₁, g₂, . . . , g_{G}) (3)

The arrangement feature calculating unit 18 calculates gᵢ respectively for the points i of the images stored in the data storing unit 12.

Here, the examples of the 4 neighbors and the 8 neighbors are described. Alternatively, the arrangement feature may be defined by two points of upper and lower parts or right and left parts, or may be defined only by one point of an upper or lower part. Further, points that define the arrangement are not necessarily located in the vicinity of itself and may be arbitrarily arranged.

The local feature vector calculated in the local feature calculating unit 16 and the arrangement feature vector calculated in the arrangement feature calculating unit 18 are collected to obtain a vector x expressed by

$$\begin{matrix}Vector x = ( vector l , vector g ) \\ = ( {l}_{1} , {l}_{2} , … , {l}_{L} , {g}_{1} , {g}_{2} , … , {g}_{G} ) \\ = ( {x}_{1} , {x}_{2} , … , {x}_{d} )\end{matrix} \qquad ( 4 )$$

This d dimensional vector x is called a feature vector x. In this case, d=L+G. A (vector x, y) having the vector x and a class label y thereof (a true value of an identifying class) indicates the above-described training sample.

As described above, when the arrangement feature is calculated, the class labels given to the training sample are used. However, a class label y′ᵢ estimated by the already obtained weak classifier can be also used. For example, when a t-th weak classifier is started to be trained, since first, second, . . . , t−1 th weak classifiers are already known, the class label y′ᵢ of the vector xᵢ of the training sample is estimated from the weak classifiers.

$${y}_{i}^{′} = sign ( {\sum }_{j = 1}^{t - 1} {h}_{j} ( {x}_{i} ) ) \qquad ( 5 )$$

The arrangement feature may be calculated by using y′ᵢ (i=1, 2, . . . , N) and may be used when the t-th weak classifier is trained. The class label yᵢ (i=1, 2, . . . , N) is a constant, however, a predicted label y′ᵢ (i=1, 2, . . . , N) changes during the process of training.

Since the predicted label y′ᵢ (i=1, 2, . . . , N) is acquired by using of the trained weak classifiers, the predicted label cannot be acquired when the first weak classifier is trained.

### (6) Weak Classifier Selecting Unit 20

The weak classifier selecting unit 20 includes, as shown in FIG. 1, the quantize unit 26, the combination generating unit 28, the probability distribution calculating unit 30 and the combination selecting unit 32 and selects a weak classifier hₜ(vector x) by considering the vector xᵢ (i=1, 2, . . . , N) of the N training samples and a weight Dₜ (i) added thereto. The detail thereof will be described below.

### (6-1) Quantize Unit 26

The quantize unit 26 initially obtains a probability distribution of each feature quantity (each element of a feature vector) for each identifying class. An example of the probability distribution is shown in FIG. 5. One curve corresponds to the probability distribution of one identifying class. In this embodiment, since a two-class identification problem is assumed, the two probability distributions are obtained for one feature.

Each feature quantity is quantized on the basis of the probability distribution. A case is shown that one threshold value for minimizing an error rate for identification is obtained and quantized in two stages. Since the error rate for identification corresponds to an area of a narrower part when the probability distribution is divided by a certain threshold value (In FIG. 5, a right area of the threshold value shown by a dotted line in the distribution of the class 1, and a left area in the distribution of the class 2), a boundary is set so as to minimize the sum of the two areas.

By using the threshold value set in such a way, each feature quantity is quantized. Namely, the feature quantity is replaced by a code showing a relative dimensional relation to the threshold value, for example, 0 when each feature quantity is smaller than the threshold value, and 1 when each feature quantity is larger than the threshold value.

Here, a method for quantizing the feature quantity in accordance with the relative dimensional relation to one threshold value is described. Alternatively, an upper limit and a lower limit may be set by two threshold values to represent the feature quantity by 0 when the feature quantity is located within the range and by 1 when the feature quantity is located outside the range. Further, the feature quantity may be quantized in three or more stages.

### (6-2) Combination Generating Unit 28

The combination generating unit 28 generates the combinations of features.

As a method for generating the combinations, a method for generating all combinations is firstly considered. Since the total number K of the combinations in this case is a total of the combinations obtained by extracting the features of 1, 2, . . . , d from the d features in all, the total number K is obtained by a below-described equation.

$$K = {\sum }_{k = 1}^{d} {}_{d}^{}{C}{}_{k}^{} \qquad ( 6 )$$

The total number K of the combinations becomes a very large figure especially when the number d of the features is large and the number of times of calculations is extremely increased. To avoid this situation, the number of features to be combined may be predetermined or an upper limit or a lower limit may be set to the number of the features to be combined. Further, since the error rate for identification is obtained when each feature quantity is encoded in the quantize unit 26, the feature quantities may be sorted in order of high identifying performance (the error rate for identification is low) on the basis of thereof and the features of the high identifying performance may be preferentially used to generate a prescribed number of combinations.

### (6-3) Probability Distribution Calculating Unit 30

The probability distribution calculating unit 30 obtains the quantities of the combinations of features respectively from the K kinds of combinations of features generated in the combination generating unit 28 to obtain the probability distribution of the quantity of the combination of the features for each identifying class.

The K combinations of the features is regarded as ck (k=1, 2, . . . , K). A below-described calculation is carried out to each ck.

### (6-3-1) Step 1

It is assumed that components of ck are f feature quantities v1, v2, . . . , vf. The f feature quantities are codes quantized in the quantize unit 26. The feature quantities may be possibly quantized respectively in different stages. However, for the purpose of simplifying an explanation, all the feature quantities are considered to be quantized in the two stages. In this case, since all the feature quantities are represented by a binary code of 0 or 1, the f combinations can be represented by a scalar quantity off bit gradation. The scalar quantity φ is called a combined feature quantity.

φ=(v1·v2· . . . ·vf)² (7)

### (6-3-2) Step 2

The probability distribution of the combined feature quantity φ is obtained for each identifying class. In this embodiment, since the number of the identifying classes is 2, two distributions W₁^{k}(φ) and W₂^{k}(φ) are obtained by a below-described equation.

$${W}_{1}^{k} ( φ ) = {\sum }_{i : {x}_{i} ∈ φ {y}_{i} = + 1} {D}_{t} ( i ) , \\ {W}_{2}^{k} ( φ ) = {\sum }_{i : {x}_{i} ∈ φ {y}_{i} = - 1} {D}_{t} ( i ) \qquad ( 8 )$$

### (6-3-3) Step 3

W₁^{k}(φ) and W₂^{k}(φ) are respectively normalized so that the total sum becomes 1.

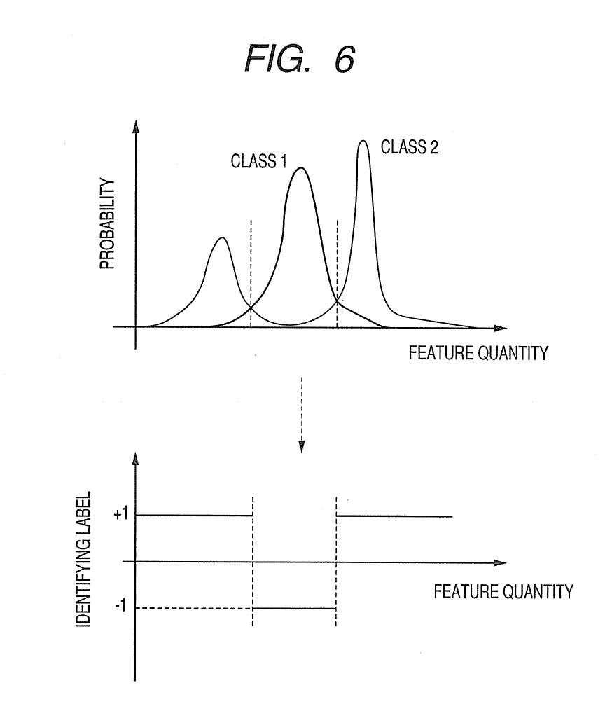

An example of the probability distribution is shown in an upper part of FIG. 6. From a certain combined feature quantity φ, which class the feature quantity likely to belongs to can be decided. That is, from a relative dimensional relation between W₁^{k}(φ) and W₂^{k}(φ), whether or not a probability is high to which class the feature quantity φ belongs can be decided.

From a compared result (class labels) of the two probability distributions, a table may be formed as shown in a lower part of FIG. 6. This is referred to as a comparing table hereinafter and represented by W₀^{k}(φ).

### (6-4) Combination Selecting Unit 32

The combination selecting unit 32 obtains error rates for identification respectively for the generated K kinds of combinations to select a combination by which the error rate for identification is minimized.

An error rate E k for identifying each combination ck (k=1, 2, . . . , K) is given by a below-described equation.

εₖ=ΣDₜ(i)

i:yᵢ≠hₖ(xᵢ) (9)

In this case, hₖ(x)=sign (W₁^{k}(φ)−W₂^{k}(φ)).

### (7) Storing Unit 22

The storing unit 22 stores identifying parameters of the weak classifiers in which a training is completed one by one.

Specifically, the identifying parameters include, for example, the threshold value used when the feature quantity is quantized, the combination ck of the selected feature quantities and the probability distributions W₁^{k}(φ) and W₂^{k}(φ) thereof. Further, as the identifying parameter, the comparing table W₀^{k}(φ) may be stored.

In the meaning of the identifying parameters corresponding to a t-th weak classifier, cₜ, W₁^{t}(φ), W₂^{t}(φ) and W₀^{t}(φ) are designated below.

### (8) Data Weight Updating Unit 24

The data weight updating unit 24 updates the weight of each training sample. The weight of an i-th training sample (xᵢ, yᵢ) is obtained by a below-described equation.

Dₜ₊₁(i)=Dₜ(i)·exp(−αₜyₜhₜ(xᵢ))/Zₜ (10)

αₜ is obtained by a below-described equation.

αₜ=½ log(1−εₜ/εₜ) (11)

In this case, εₜ is the total sum of the weights of the training samples erroneously identified by the weak classifier hₜ(x) and given by

εt=ΣDₜ(i)

i:yᵢ≠hₜ(xᵢ) (12)

Further, Zₜ is a normalizing coefficient for setting the sum of the weights to land given by a below-described equation.

$${Z}_{t} = {\sum }_{i = 1}^{N} {D}_{t} ( i ) exp ( - {α}_{t} {y}_{i} {h}_{t} ( {x}_{i} ) ) \qquad ( 13 )$$

An initial value D₁(i) of Dₜ(i) is obtained by the equation (1).

The weight updating unit 24 increases the weight of sample data that is not correctly identified by the weak classifier hₜ(x) and decreases the weight of data that is correctly recognized, so that a next weak classifier hₜ₊₁(x) has a high identifying performance to the sample data that cannot be identified the last time. A plurality of these weak classifiers are integrated to obtain an identifying device of a high performance as a whole. A final identifying device is obtained by a below-described equation (14) in which T weak classifiers hₜ(x) (t=1, 2, . . . , T) are weighted by a reliability αₜ given by the equation (11) to take a majority decision.

$$H ( x ) = sign ( {\sum }_{t = 1}^{T} {α}_{t} {h}_{t} ( x ) ) \qquad ( 14 )$$

### (Pattern Recognizing Device 50)

The pattern recognizing device 50 of an embodiment will be described by referring to the drawings.

### (1) Structure of Pattern Recognizing Device 50

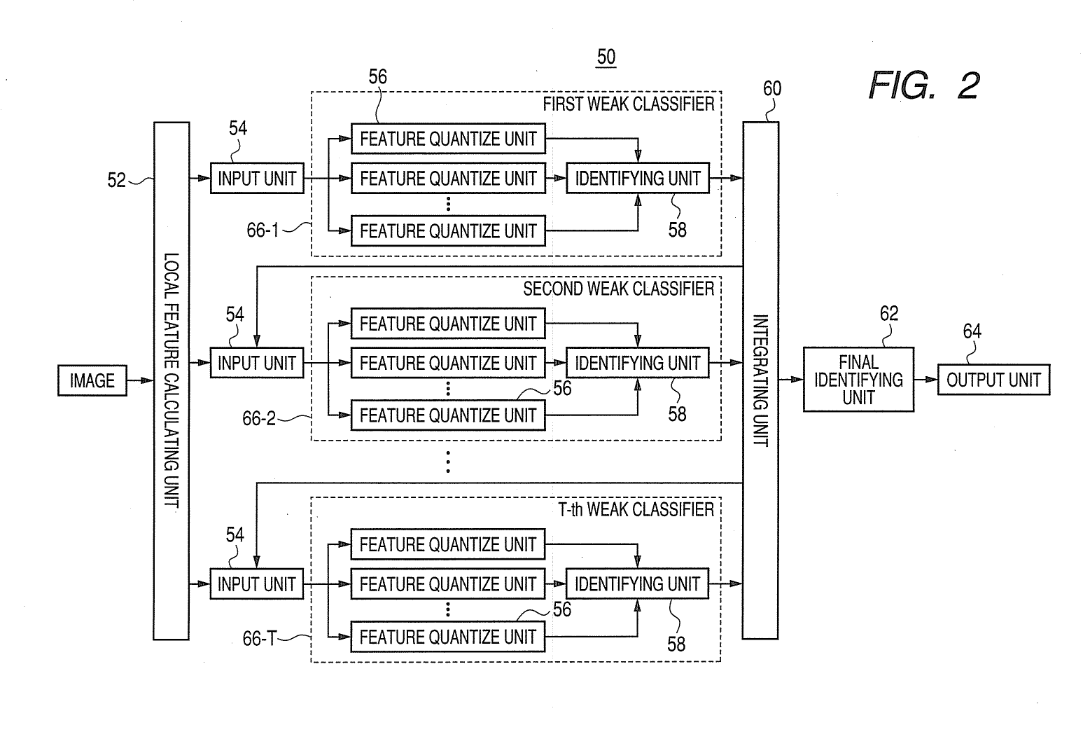

FIG. 2 shows a block diagram of the pattern recognizing device 50 in this embodiment. The pattern recognizing device 50 includes a local feature calculating unit 52, an input unit 54, a feature quantize unit 56, an identifying unit 58, an integrating unit 60, a final identifying unit 62 and an output unit 64.

The pattern recognizing device 50 has a plurality of weak classifiers 66 including a first weak classifier 66-1, a second weak classifier 66-2, . . . , a T-th weak classifier 66-T. The each weak classifier 66 includes a plurality of feature quantize units 56 and the identifying units 58. The weak classifiers 66 are sequentially designated in order from an upper part by a first weak classifier 66-1, a second weak classifier 66-2, . . . , a T-th weak classifier 66-T. Here, “the weak classifier 66” means an identifying device and “the weak classifier h(x)” means an identifying function used in the weak classifier 66. The weak classifiers h(x) are trained by the above-described training device 10 and it is assumed that the identifying parameters such as the threshold value necessary for a process are already obtained.

### (2) Local Feature Calculating Unit 52

The local feature calculating unit 52 scans an input image with the width of a prescribed step from the position of an origin to obtain local features respectively for points. The local features are the same as the L local features l₁, l₂, l_{L} used in the local feature calculating unit 16 of the training device 10. An L dimensional vector l is expressed by, as in the training device 10, by

Vector l=(l₁, l₂, . . . , l_{L}) (15)

The local feature vector l is calculated for each point identified on the input image. When the number of the points to be identified is N, N local feature vectors lᵢ (i=1, 2, . . . , N) are output from the local feature calculating unit 52.

An identifying calculation is carried out on the basis of these features. However, when there is exists the feature that is not used in any of the weak classifiers, the feature is invalid for an identification and below-described processes are not necessary. Therefore, a calculation for the feature is not carried out, and a suitable default value is input for the feature. Thus, a calculation cost can be reduced.

### (3) Input Unit 54

The input unit 54 is provided for each weak classifier 66 as shown in FIG. 2 and inputs the N L-dimensional local feature vectors l calculated in the local feature calculating unit 52 and a G dimensional arrangement feature vector g calculated in the integrating unit 60 respectively to each weak classifier 66.

The arrangement feature vector g is basically the same as that used in the above-described training device 10, however, is calculated in a below-described integrating unit 60 of the pattern recognizing device 50.

Since the class labels of each training sample are known in the training device 10, the arrangement feature can be calculated from the known labels. However, in the pattern recognizing device 50, since class labels are unknown, an arrangement feature is calculated by using labels estimated one by one. N local feature vectors l and N arrangement feature vectors g are generated, and one of the N local feature vectors 1 and one of the N arrangement feature vectors g are input. As in the training device 10, a d dimensional vector x formed with the local feature vector and a spatial arrangement vector is considered to be a feature vector. The vector x is input to the weak classifier. The vector x is expressed by

$$\begin{matrix}Vector x = ( vector l , vector g ) \\ = ( {l}_{1} , {l}_{2} , … , {l}_{L} , {g}_{1} , {g}_{2} , … , {g}_{G} ) \\ = ( {x}_{1} , {x}_{2} , … , {x}_{d} )\end{matrix} \qquad ( 16 )$$

In this case, d=L+G.

Only the local feature vector l is input to the first weak classifier 66-1. In this case, elements of the spatial arrangement vector are respectively initialized by a suitable default value, for example, −1. Namely,

$$\begin{matrix}Vector x = ( vector l , vector g ) \\ = ( {x}_{1} , {x}_{2} , … , {x}_{g} ) \\ = ( - 1 , - 1 , … , - 1 )\end{matrix} \qquad ( 17 )$$

Hereinafter, it is assumed that the d dimensional feature vector x=(x₁, x₂, . . . , x_{d}) are input to all the weak classifiers 66.

### (4) Weak Classifier 66

Each weak classifier 66 will be described below.

The T weak classifiers 66 respectively have different combinations of features used for identification and different threshold values used for quantization, however, the basic operations thereof are common.

### (4-1) Feature Quantize Unit 56

A plurality of feature quantize units 56 provided in each of the weak classifiers 66 correspond to features different from each other in each weak classifier 66 and quantize the corresponding features in a plurality of stages. A feature to be quantized by each feature quantize unit 56, a threshold value used for quantization or in what stages the feature is quantized is obtained by the above-described training device 10.

For example, an output value θ, which is obtained when a certain feature quantize unit 56 quantizes a feature quantity in two stages by a threshold value thr, is calculated by a below-described equation.

θ={0 xᵢ≦thr

1 otherwise (18)

When the number of the feature quantize units 56 is F, F outputs θ_{f} (f=1, 2, . . . , F) are obtained.

### (4-2) Identifying Unit 58

The identifying unit 58 inputs the F quantized features θ_{f} (f=1, 2, . . . , F) to output an identified result.

In this embodiment, a two-class identification problem is considered and an output value is −1 or +1.

Firstly, in an identification, a combined feature quantity φ described in the training device 10 is calculated from the combinations of the F quantized features θ_{f} (f=1, 2, . . . , F).

Then, a probability of that the combined feature quantity φ is observed from each of the identifying classes is decided by referring to the probability distributions W₁^{t}(φ) and W₂^{t}(φ) of the identifying classes stored in the storing unit 22 of the training device 10. And, the identifying class is determined in accordance with a relative dimensional relation of the probability distributions W₁^{t}(φ) and W₂^{t}(φ).

A comparing table W₀^{t}(φ) may be referred to in place of the two probability distributions.

### (5) Integrating Unit 60

The integrating unit 60 sequentially integrates the identified results respectively output from the weak classifiers 66 to calculate the arrangement features of the points respectively.

For example, a time is considered when processes of a t-th weak classifier 66-t (in this case, 1=<t=<T) are completed.

Initially, an integrated value s (vector x) is obtained by a below-described equation from the t weak classifiers hᵢ(vector x) (i=1, 2, . . . , t) on which a training is completed.

$$s ( x ) = {\sum }_{i}^{t} {α}_{i} {h}_{i} ( x ) \qquad ( 19 )$$

αᵢ (i=1, 2, . . . , t) is a parameter determined for each weak classifier 66 and represents a reliability of each weak classifier 66. This parameter is obtained by the training device 10.

Then, a class label β (vector x) of vector x is estimated from the integrated value s(x). For example, the β(vector x) is estimated by the plus and minus of the s (vector x). When N feature vectors x (vector xᵢ) (i=1, 2, . . . , N) are estimated, the N class labels β (vector xᵢ) (i=1, 2, . . . , N) are obtained. From the N class labels β (vector xᵢ) (i=1, 2, . . . , N), the arrangement features used in the training device 10 are obtained.

When there is an arrangement feature that is not used in any of the weak classifiers 66 as in the calculation of the local feature, since the arrangement feature is invalid for an identification, the arrangement feature does not need to be calculated.

When the identified result from the T-th weak classifier 66-T is input, the integrated value of the feature vectors is output to the final identifying unit 62.

### (6) Final Identifying Unit 62

The final identifying unit 62 finally decides the identifying classes of the points from the final integrated value s_{T} (vector x) of the points. Generally, in the two-class identification problem, the class labels are determined by the plus and minus of the s_{T} (vector x).

### (7) Output Unit 64

The output unit 64 outputs the final identifying class label values of the respective points.

### (8) Effect

As described above, an identifying process is carried out on the basis of the combinations of a plurality of local features and the arrangement features so that a pattern can be recognized more highly accurately than usual. In other word, in this embodiment, an equal identifying performance can be obtained with a lower calculation cost than usual.

### MODIFIED EXAMPLE

The present invention is not directly limited to the above-described embodiment and components may be modified in an embodying process and embodied within a range without departing from the gist thereof. Further, various inventions may be devised by suitably combining a plurality of components disclosed in the above-described embodiment. For example, some components may be deleted from all the components disclosed in the embodiment. Further, components in a different embodiment may be properly combined together. Otherwise, a modification can be realized within a range without departing from the gist of the invention.

### (1) Modified Example 1

In this embodiment, a two-class identification problem is assumed. However, for example, a plurality of strong classifiers may be combined together to be applied to a multi-class identification problem.

### (2) Modified Example 2

In the above-described embodiment, the AdaBoost is used as a training algorithm, however, other Boosting method may be used.

For example, a method called Real AdaBoost may be used and is described in the Document “R. E. Schapire and Y, Singer, “Improved Boosting Algorithms Using Confidence-rated Predictions”, Machine Training, 37, pp. 297-336, 1999”

According to an aspect of the present invention, a pattern recognition with a higher accuracy at an equal calculation cost or an equal performance at a lower calculation cost than that of a usual case can be realized.

What is claimed is:

1. A training device for a strong classifier configured to classify class of images of areas in an object image, the strong classifier comprising a plurality of weak classifiers, the training device comprising:
a sample image storing unit configured to store sample images for training;
a local information calculator configured to acquire a local information for each of local images of divided areas in each of the sample images; and
a weak classifier training unit configured to train, based on the local information, a first weak classifier that is one of the weak classifiers, the weak classifier training unit comprising:
an arrangement information calculator configured to acquire an arrangement information comprising a positional relation information between each of marked areas located in each of the sample images and each of peripheral areas located on periphery of each of the marked areas and an identifying class information that is previously identified for each of the peripheral areas,
a combined information selector configured to select a first combined information from a plurality of combined informations being generated by combining the local information and the arrangement information, and
an identifying parameter calculator configured to acquire, based on the first combined information, a first identifying parameter for the first weak classifier.

2. The training device according to claim 1, further comprising:
an identifying class storing unit configured to store the identifying class information; and
a weight setting unit configured to set, for each of the weak classifiers, a weight of a training sample comprising a correlation between the identifying class information and the areas;
wherein the parameter calculator acquires the first identifying parameter based on the first combined information and the weight.

3. The training device according to claim 1, wherein the combined information selector selects, as the first combined information, one of the plurality of combined informations that is capable of identifying the sample images with a lowest error rate thereamong.

4. The training device according to claim 1, wherein the local information comprises a graphical feature.

5. The training device according to claim 1, wherein each of the peripheral areas comprises peripheral points of each of the marked areas.

6. The training device according to claim 1, wherein the identifying class information is previously identified and used as a true value.

7. The training device according to claim 1, wherein the arrangement information is acquired by using of an output value of a previously-generated weak classifier.

8. A pattern recognizing device comprising:
an input unit configured to input an object image;
a local information calculator configured to acquire a local information used for identifying areas in the object image;
T of arrangement information calculators configured to acquire T of arrangement informations based on an estimated identifying class information for each of peripheral areas located on periphery of each of marked areas located in the object image and based on a positional relation information between each of the marked areas and each of the peripheral areas;
T of weak classifiers configured to acquire T of weak identifying class informations respectively for each of the areas based on the local information and based on each of the arrangement informations; and
a final identifying unit configured to acquire a final identifying class for each of the areas based on the weak identifying class informations;
wherein T is an integer larger than 1.

9. The pattern recognizing device according to claim 8, wherein the weak classifiers comprises T of identifying parameters set based on T of combined informations being generated by combining the local information and each of the arrangement informations.

10. The pattern recognizing device according to claim 8, wherein a t-th of arrangement information of the arrangement informations is acquired by combining others of weak identifying class informations except a t-th of weak identifying class information from the weak identifying class informations; and
wherein t is an integer larger than 1 and equal to or smaller than T.

11. The pattern recognizing device according to claim 8, wherein a t-th of arrangement information of the arrangement informations is acquired by combining first to (t−1)-th of weak identifying class informations of the weak identifying class informations; and
wherein the final identifying unit outputs the final identifying class by combining the weak identifying class informations; and
wherein t is an integer larger than 1 and equal to or smaller than T.

12. A method for training a strong classifier configured to classify class of images of areas in an object image, the strong classifier comprising a plurality of weak classifiers, the method comprising:
storing sample images for training;
acquiring a local information for each of local images of divided areas in each of the sample images; and
training, based on the local information, a first weak classifier that is one of the weak classifiers, the step of training comprising:
acquiring an arrangement information comprising a positional relation information between each of marked areas located in each of the sample images and each of peripheral areas located on periphery of each of the marked areas and an identifying class information that is previously identified for each of the peripheral areas,
selecting a first combined information from a plurality of combined informations being generated by combining the local information and the arrangement information, and
acquiring, based on the first combined information, a first identifying parameter for the first weak classifier.

13. A method for recognizing a pattern, comprising:
inputting an object image;
acquiring a local information used for identifying areas in the object image;
acquiring T of arrangement informations based on an estimated identifying class information for each of peripheral areas located on periphery of each of marked areas located in the object image and based on a positional relation information between each of the marked areas and each of the peripheral areas;
acquiring T of weak identifying class informations respectively for each of the areas based on the local information and based on each of the arrangement informations; and
acquiring a final identifying class for each of the areas based on the weak identifying class informations;
wherein T is an integer larger than 1.

14. A computer program product for enabling a computer system to perform a training of a strong classifier configured to classify class of images of areas in an object image, the strong classifier comprising a plurality of weak classifiers, the computer program product comprising:
software instructions for enabling the computer system to perform predetermined operations; and
a computer readable medium storing the software instructions; wherein the predetermined operations comprising:
storing sample images for training;
acquiring a local information for each of local images of divided areas in each of the sample images; and
training, based on the local information, a first weak classifier that is one of the weak classifiers, the step of training comprising:
acquiring an arrangement information comprising a positional relation information between each of marked areas located in each of the sample images and each of peripheral areas located on periphery of each of the marked areas and an identifying class information that is previously identified for each of the peripheral areas,
selecting a first combined information from a plurality of combined informations being generated by combining the local information and the arrangement information, and
acquiring, based on the first combined information, a first identifying parameter for the first weak classifier.

15. A computer program product for enabling a computer system to perform a pattern recognition, the computer program product comprising:
software instructions for enabling the computer system to perform predetermined operations; and
a computer readable medium storing the software instructions; wherein the predetermined operations comprising:
inputting an object image;
acquiring a local information used for identifying areas in the object image;
acquiring T of arrangement informations based on an estimated identifying class information for each of peripheral areas located on periphery of each of marked areas located in the object image and based on a positional relation information between each of the marked areas and each of the peripheral areas;
acquiring T of weak identifying class informations respectively for each of the areas based on the local information and based on each of the arrangement informations; and
acquiring a final identifying class for each of the areas based on the weak identifying class informations;
wherein T is an integer larger than 1.
